(19) United States
(12) Patent Application Publication
(10) Pub. No.: US 2009/0199782 A1
(43) Pub. Date: Aug. 13, 2009

(54) Modular Animalia Housing Apparatus

(75) Inventors: Anthony X. Drumm, Rockwood, MI (US); Kevin L. Hiner, Canton, MI (US); David M. Minkley, Chesterfield, MI (US); Matthew J. Sicken, Chesterfield, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Polymerica Limited Company, El Paso, TX (US)

(21) Appl. No.: 12/367,958

(22) Filed: Feb. 9, 2009

Related U.S. Application Data
(60) Provisional application No. 61/027,244, filed on Feb. 8, 2008.

(51) Int. Cl. A01K 1/03; A01K 1/00

(52) U.S. Cl. 119/498; 119/482

(57) ABSTRACT

A modular animalia housing apparatus is disclosed. The modular animalia housing apparatus includes one or more housing portions, wherein the one or more housing portions each includes a substantially tube-shaped body member having a first end connected to a second end, wherein the substantially tube-shaped body member is formed from a substantially planar member including a length, a width, and a thickness, wherein the length includes a first length segment, a second length segment, and a third length segment, wherein the second length segment is joined to the first length segment and the third length segment, where the first end includes the first length segment, wherein the second end includes the third length segment, wherein the second length segment includes the thickness, wherein the first length segment includes a first thickness portion that is less than the thickness, wherein the third length segment includes a second thickness portion that is less than the thickness, wherein a sum of the first thickness portion and the second thickness portion is approximately equal to the thickness. A kit for assembling modular animalia housing apparatus is also disclosed.

### RELATED APPLICATION

This application claims priority to, and herein incorporates by reference the entire contents of U.S. provisional patent application Ser. No. 61/027,244 filed on Feb. 8, 2008.

### FIELD OF THE INVENTION

The invention generally relates to modular structures and more specifically to a modular structure including a plurality of components, that, when assembled together, may assist, house, or entertain one or more species of animalia.

### DESCRIPTION OF THE RELATED ART

Devices that are to be provided for one or more species of animalia are commercially available. Although conventional devices have been proven to be useful, such devices are nevertheless susceptible to improvements that may enhance or improve their service life and/or performance. Further, some conventional devices are heavy, bulky or the like, and, therefore, do not conform to low cost shipping methodologies. Therefore, a need exists in the art for the development of an improved device.

### BRIEF DESCRIPTION OF THE DRAWINGS

The disclosure will now be described, by way of example, with reference to the accompanying drawings, in which:

FIG. 1 is a perspective view of a modular animalia housing apparatus being utilized by a feline in accordance with an embodiment of the invention;

FIG. 2A is a perspective view of a plurality of “shipped flat,” packaged components of a modular animalia housing apparatus in accordance with an embodiment of the invention;

FIG. 2B is a perspective view of a plurality of “shipped flat,” unpackaged components of a modular animalia housing apparatus in accordance with an embodiment of the invention;

FIG. 3A is a perspective view of some of a plurality of “shipped flat” components of a modular animalia housing apparatus in an unassembled state in accordance with an embodiment of the invention;

FIG. 3B is a side view of a “shipped flat” component of a modular animalia housing apparatus of FIG. 3A in accordance with an embodiment of the invention;

FIG. 4 is a cross-sectional view of some of a plurality of components of a modular animalia housing apparatus in a partially assembled state according to line 4-4 of FIG. 6 in accordance with an embodiment of the invention;

FIG. 5 is a side, cross-sectional view of some of a plurality of components of a modular animalia housing apparatus in a partially assembled state in accordance with an embodiment of the invention;

FIG. 6 is a perspective view of some of a plurality of components of a modular animalia housing apparatus in a partially assembled state in accordance with an embodiment of the invention;

FIG. 7 is a side, cross-sectional view of some of a plurality of components of a modular animalia housing apparatus in a partially assembled state according to line 7-7 of FIG. 6 in accordance with an embodiment of the invention;

FIG. 8 is a front, cross-sectional view of some of a plurality of components of a modular animalia housing apparatus in a partially assembled state according to line 8-8 of FIG. 7 in accordance with an embodiment of the invention;

FIG. 9 is a front view of a plurality of components of a modular animalia housing apparatus in a partially assembled state in accordance with an embodiment of the invention;

FIG. 10 is a cross-sectional view of a component of a modular animalia housing apparatus according to line 10-10 of FIG. 9 in accordance with an embodiment of the invention;

FIG. 11 is a perspective view of an assembled, modular animalia housing apparatus in accordance with an embodiment of the invention; and

FIGS. 12A-12D each illustrate a plurality of configurations of the modular animalia housing apparatus in accordance with an embodiment of the invention.

### DETAILED DESCRIPTION OF THE INVENTION

The Figures illustrate an exemplary embodiment of a novel modular animalia housing apparatus in accordance with an embodiment of the invention. Based on the foregoing, it is to be generally understood that the nomenclature used herein is simply for convenience and the terms used to describe the invention should be given the broadest meaning by one of ordinary skill in the art.

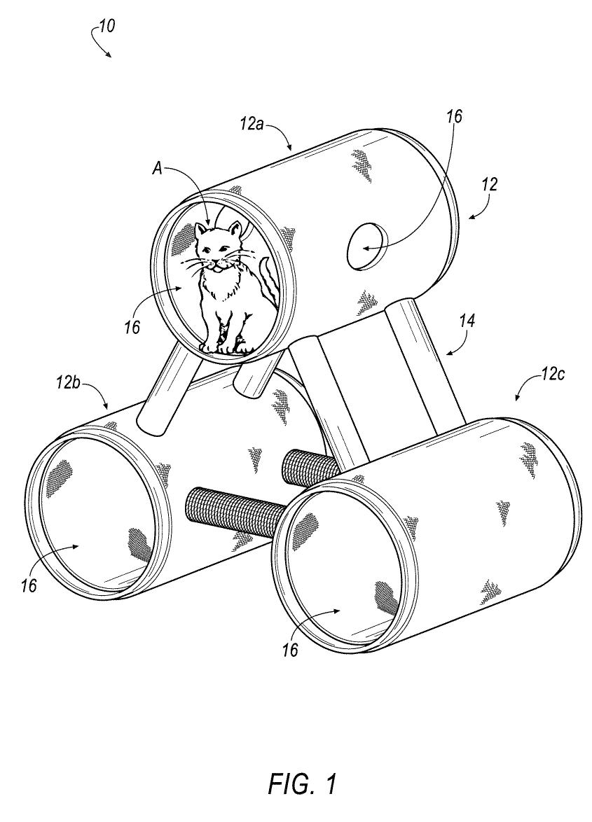

Referring to FIG. 1, a modular animalia housing apparatus is shown generally at 10 in accordance with an embodiment of the invention. In an embodiment, the modular animalia housing apparatus 10 may include a plurality of housing portions 12 and a plurality of connecting portions 14 that join at least a first housing portion 12a of the plurality of housing portions 12 to one or more supplementary housing portions 12b, 12c of the plurality of housing portions 12.

In an embodiment, each housing portion 12a-12c may include a passage, recess or the like, which is shown generally at 16. The passage/recess 16 may permit one or more animals, A, to utilize the modular animalia housing apparatus 10 for any desirable purpose (e.g. loitering, lounging, sitting, resting, playing, climbing, scratching, chewing or the like).

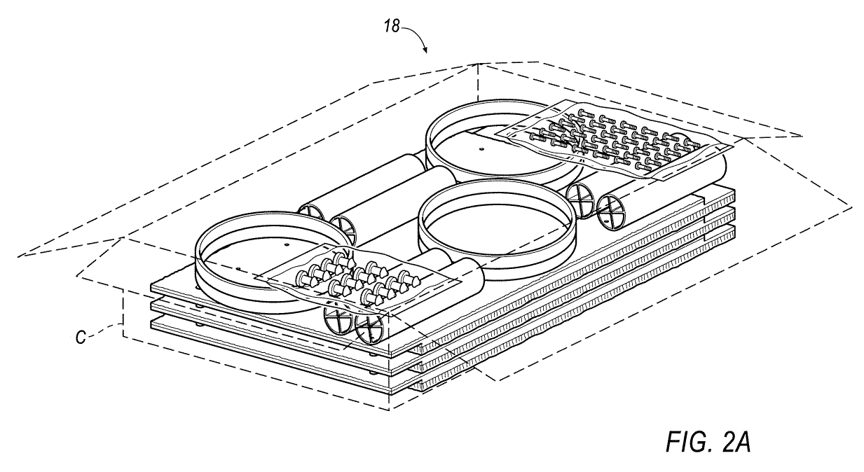

It will be appreciated that although the animal, A, of FIG. 1 is illustrated to include a feline/cat, it will be appreciated that the modular animalia housing apparatus 10 is not limited to felines/cats, and, as such, may also/alternatively accommodate canines/dogs, ferrets, birds, rodents or humans (e.g., including, but not limited to small children, teenagers, adults or the like). It will be appreciated that if, for example, a particular type of animal (e.g. a relatively heavy animal) is permitted/intended to utilize the modular animalia housing apparatus 10, a plurality of structural components 18 (see, e.g., FIGS. 2A-2B) associated with the assembly of the modular animalia housing apparatus 10 may be purposefully selected to have a particular rigidity, tensile strength, or the like in order to maintain the structural integrity of the modular animalia housing apparatus 10. Further, it will be appreciated that one or more of the plurality of structural components 18 may be designed with a co-linear geometry such that the one or more of the plurality of structural components 18 may be fabricated using any desirable extrusion technique.

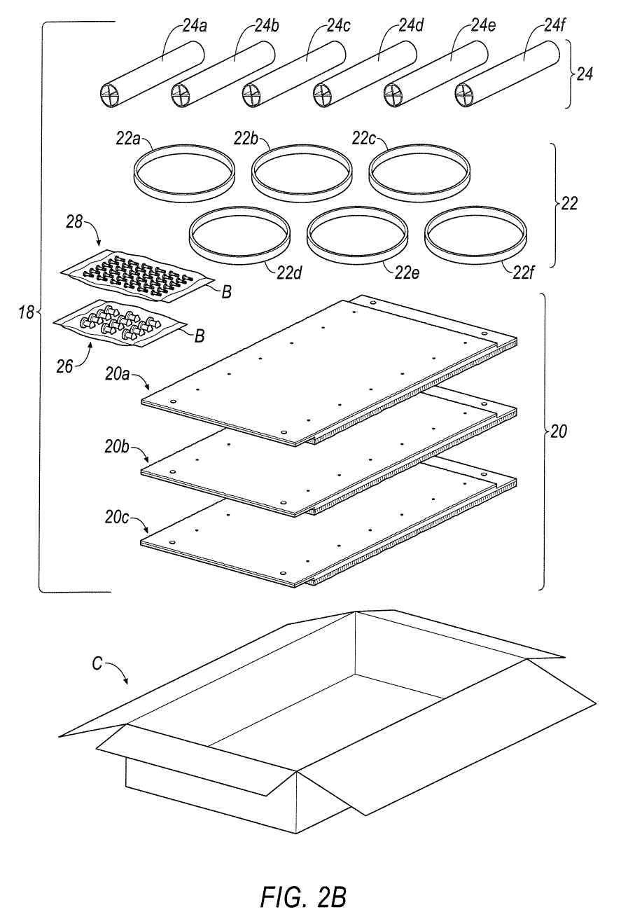

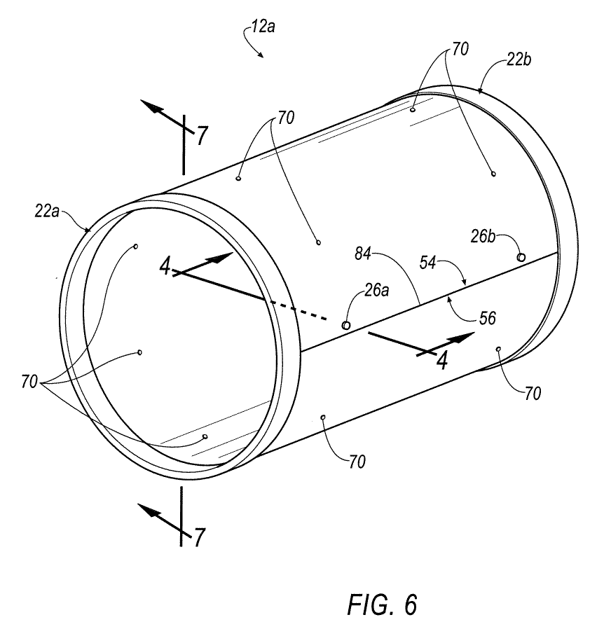

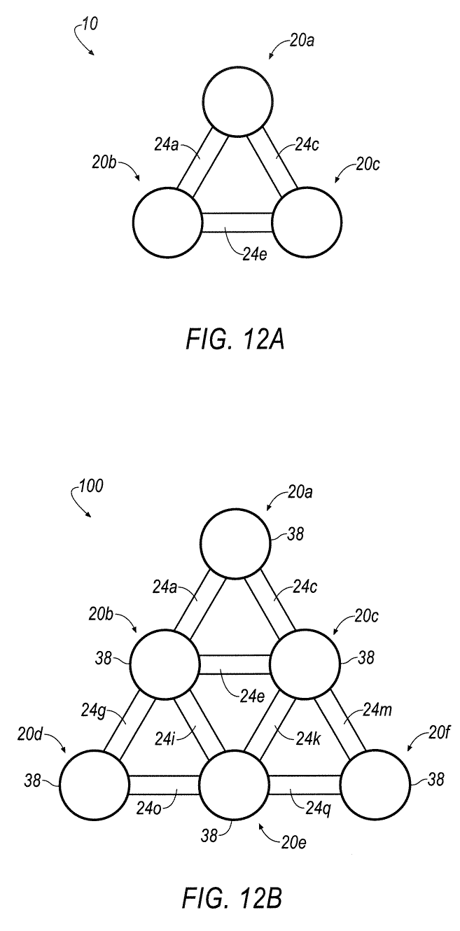

Referring to FIGS. 2A-2B, the plurality of structural components 18 may be compactly packaged into a container, C, shipping box, or the like. In an embodiment, the plurality of components 18 may define a kit such that the size, shape, dimension, orientation or other structural geometry of the plurality of components 18 permits each component of the plurality of components 18 to be adapted to be manipulated from, for example, a first, “shipped flat” orientation to an assembled orientation. Further, the plurality of components 18 defining the kit may also be adapted to be connected to one another in order to provide an assembled modular animalia housing apparatus 10. Accordingly, in an embodiment, a user may a) receive the container, C, in a closed/sealed state, b) open the container, C (see, e.g., FIG. 2A), c) unpack/retrieve the plurality of structural components 18 from the container, C (see, e.g., FIG. 2B), and d) assemble the plurality of structural components 18 together (see, e.g., FIGS. 3-10) in order to provide the modular animalia housing apparatus 10 for usage by the animal, A (see, e.g., FIGS. 1 and 11).

Referring to FIG. 2B, the plurality of structural components 18 may include, for example, a plurality of housing body members 20, a plurality of ring members 22, a plurality of beam members 24, a first plurality of fasteners 26 and a second plurality of fasteners 28. In an embodiment, each of the first and second plurality of fasteners 26, 28 may, for example, be stowed in one or more sealed bags, B, prior to assembling the modular animalia housing apparatus 10.

In an embodiment, the plurality of structural components 18 may include a two-to-one ratio of components (e.g. two ring members 22a-22f for every housing body member 20a-20c/two beam members 24a-24f for every housing body member 20a-20c). It will be appreciated, however, that the ratio of components included in the plurality of structural components 18 is not limited to include a particular number/amount and that the invention may be practiced with any desirable number of structural components 18.

Referring to FIG. 2A, the plurality of components 18 may be packaged in a substantially compact state within the container, C, such that it may be said that one or more of the plurality of components 18 are “shipped flat.” By packaging the plurality of components 18 in a substantially compact state, a plurality of containers, C, may be shipped from, for example, a manufacturing site to, for example, a warehouse, wholesaler, retailer, or the like. Further, it will be appreciated that the materials associated with the plurality of components 18 may be selected in order to reduce the collective weight of the plurality of component 18 when packaged within the container, C; however, it will be appreciated that the selection of the materials may also take into consideration a particular rigidity, tensile strength, or the like in order to maintain the structural integrity of the modular animalia housing apparatus 10 as described above. Accordingly, it will be appreciated that the costs associated with the shipping of the plurality of containers, C, may be reduced in order to render the packaged container, C, to be as light as possible. Further, it will be appreciated that the “shipped flat” packaging of the container, C, will provide the manufacturer with the ability to increase the number of containers, C, that may be packaged into a shipping crate (not shown) at a manufacturing site, thereby maximizing profitability by not having to utilize the services of additional shipping crates.

Referring to FIG. 2B, once received by a consumer, the plurality of components 18 may be removed from the container, C. In an embodiment, prior to assembling the plurality of components 18 into a structure that substantially defines the modular animalia housing apparatus 10, the consumer, C, may unpack the first and second plurality of fasteners 26, 28 from the one or more sealed bags, B.

In an embodiment, the first plurality of fasteners 26 may include, for example, “one-way” push-type fasteners (e.g. “Christmas Tree fasteners”). In an embodiment, the second plurality of fasteners 28 may include, for example, threaded fasteners (e.g., screws). Although Christmas-Tree fasteners 26 and screws 28 are shown, it will be appreciated that the invention is not limited to including a particular type of fastener 26, 28 and that any desirable fastener may be utilized, such as, for example, hook-and-loop fasteners (e.g. VELCRO®). Further, although fasteners 26, 28 are discussed above, it will be appreciated that the invention is not limited to including fasteners and that other fastening techniques may be utilized to assemble the modular animalia housing apparatus 10 such as, for example, adhesives, mechanical interference fits, tape, thread, latches and the like.

Referring to FIGS. 3A and 3B, a body member 20a of the plurality of housing body members 20 and a pair of first fasteners 28a, 28b of the first plurality of fasteners 28 are shown according to an embodiment of the invention. In an embodiment, the body member 20a includes a length, L, a width, W, and a thickness, T.

In an embodiment, as seen in FIG. 3B, the length, L, may include a first length segment, L1, a second length segment, L2, and a third length segment, L3. In an embodiment, the second length segment, L2, may be defined by the thickness, T. In an embodiment, the first length segment, L1, may include a first thickness portion, T1, and, the third length segment, L3, may include a second thickness portion, T2. In an embodiment, the sum of the first and second thickness portions, T1, T2, may be approximately equal to the thickness, T, of the second length portion, L2.

In an embodiment, as seen in FIG. 3A, the body member 20a may be further defined by a first longitudinal side surface 30, a second longitudinal side surface 32, a first lateral side surface 34, a second lateral side surface 36, an outer surface 38 and an inner surface 40. In an embodiment, each of the outer surface 38 and the inner surface 40 may include a first surface portion 42, 44 and a second surface portion 46, 48 that are demarcated and connected by an intermediate surface portion 50, 52. In an embodiment, the intermediate surface portion 50, 52 may be substantially perpendicular to the first surface portion 42, 44 and the second surface portion 46, 48. In an embodiment, the body member 20a may be further defined to include a first end 54 and a second end 56.

In an embodiment, the first end 54 may be defined by the first lateral side surface 34, the first surface portion 44, the intermediate surface portion 52 and a portion 58 (see, e.g., FIG. 3B) of the outer surface 38. In an embodiment, the portion 58 of the outer surface 38, which is hereinafter referred to as a first portion 58, may be defined by the width, W, and the first length segment, L1. In an embodiment, the first end 54 may be further defined by the first length segment, L1, and the first thickness portion, T1. In an embodiment, the first end 54 may also include one or more first passages 60 that extend through the first thickness portion, T1, from the first surface portion 44 to the first portion 58 of the outer surface 38.

In an embodiment, the second end 56 may be defined by the second lateral side surface 36, the first surface portion 42, the intermediate surface portion 50 and a portion 62 (see, e.g., FIG. 3B) of the inner surface 40. In an embodiment, the portion 62 of the inner surface 40, which is hereinafter referred to as a first portion 62, may be defined by the width, W, and the third length segment, L3. In an embodiment, the second end 56 may be further defined by the third length segment, L3, and the second thickness portion, T2. In an embodiment, the second end 56 may also include one or more second passages 64 that extend through the second thickness portion, T2, from the first surface portion 42 to the first portion 62 of the inner surface 40.

In an embodiment, the outer surface 38 may also include a second portion 66 (see, e.g., FIG. 3B) that may be defined by the width, W, and the second length segment, L2. Similarly, in an embodiment, the inner surface 40 may include a second portion 68 (see, e.g., FIG. 3B) that may be defined by the width, W, and the second length segment, L2. In an embodiment, the body member 20a may also include one or more third passages 70 that extend through the second length segment, L2, from the second portion 66 of the outer surface 38 to the second portion 68 of the inner surface 40.

In an embodiment, as seen in FIG. 3A, a first layer of material 72 may be disposed adjacent the outer surface 38 of the body member 20a. In an embodiment, the first layer of material 72 may include one or more passages 60a, 70a extending through its thickness, T₇₂, that correspond to the one or more first passages 60 and the one or more third passages 70 of the body member 20a. In an embodiment, the first layer of material 72 may include but is not limited to, for example, any desirable aesthetically-pleasing material, such as, for example, an un/woven fabric, tufted carpeting, felt, cork, fleece or the like that may include, for example, a decorative pattern, color or the like.

In an embodiment, a second layer of material 74 may be disposed adjacent the inner surface 40 of the body member 20a. In an embodiment, the second layer of material 74 may include one or more passages 64a, 70b extending through its thickness, T₇₄, that correspond to the one or more second passages 64 and the one or more third passages 70 of the body member 20a. In an embodiment, the second layer of material 74 may include but is not limited to, for example, any desirable aesthetically-pleasing material, such as, for example, an un/woven fabric, tufted carpeting, felt, cork, fleece or the like that may include, for example, a decorative pattern, color or the like.

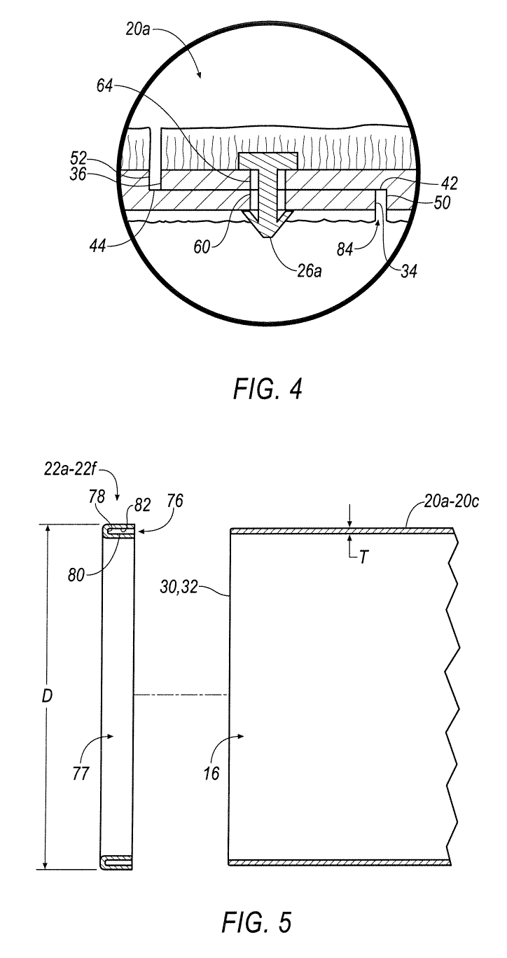

In an embodiment, the user may initiate the assembling procedure of the modular animalia housing apparatus 10 by changing the orientation of the body member 20a from a substantially “shipped flat” orientation (see, e.g., FIGS. 3A, 3B) to a rolled, substantially tube-shaped orientation (see, e.g., FIG. 6). When oriented to the rolled, substantially tube-shaped orientation, the body member 20a may generally define a housing portion 12a of the plurality of housing portions 12.

In an embodiment, the body member 20a may include any desirable material that permits the body member 20a to be arranged in one or more of a substantially planar “shipped flat” orientation and a rolled, substantially tube-shaped orientation. For example, in an embodiment, the body member 20a may include, any material capable of flexing, such as paper material (e.g. a paperboard, cardboard, or the like), wood, wood composites, wood venire, sheet metal, MYLAR®, MYLAR® composites, nylon, nylon composites, resin, resin composites, carbon, carbon composites, or the like. In an embodiment, if desirable, the body member 20a may be substantially planar, as shown, for example, in the Figures, or, alternatively, include a corrugated/substantially sinusoidal thickness that may further assist/permit the body member 20a to be re-orientated from a substantially planar orientation to a rolled orientation.

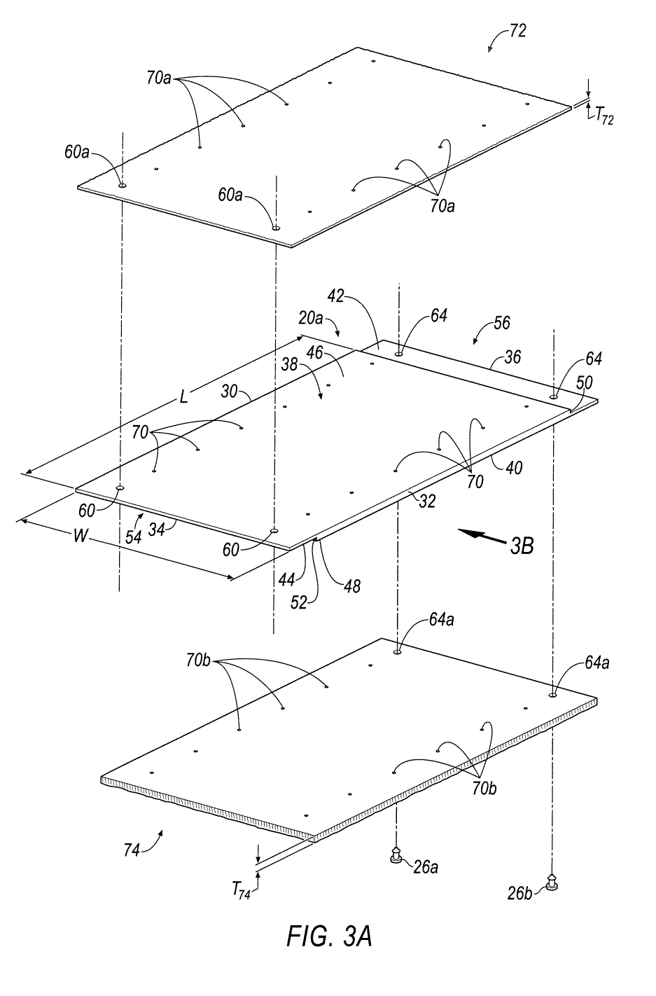

Referring to FIGS. 3A-4, in an embodiment, in order to arrange the body member 20a in a rolled, substantially tube-shaped orientation, one or more of the first lateral side surface 34, the first surface portion 44, the intermediate surface portion 52 of the first end 54 may be arranged substantially proximate/adjacent one or more of the second lateral side surface 36, the first surface portion 42, the intermediate surface portion 50 of the second end 56. Once the surfaces 34, 36, 42, 44, 50 and 52 are arranged as described above, one or more first fasteners 26a, 26b of the first plurality of fasteners 26 may be inserted through the one or more first passages 60 and the one or more second passages 64. Upon inserting the one or more first fasteners 26a, 26b through the one or more first and second passages 60, 64, the body member 20a may be at least partially secured in a rolled, substantially tube-shaped orientation. As mentioned above, it will be appreciated that the usage of the first fasteners 26a, 26b may be obviated such that an alternative fastener means/technique (e.g., adhesive, VELCRO® or the like) may be applied to one or more of the surfaces 34, 36, 42, 44, 50 and 52.

Referring to FIG. 2B a first ring member 22a and a second ring member 22b may be selected from the plurality of ring members 22 for subsequent attachment to the rolled, substantially tube-shaped body member 20a. In an embodiment, each ring member 22a-22f may include, but it not limited to, any desirable material such as, for example, a paper material (e.g. a paperboard, cardboard, or the like), wood, wood composite, wood venire, a sheet metal material, a synthetic material such as nylon, plastic resin, resin composite, carbon, carbon composite, or the like.

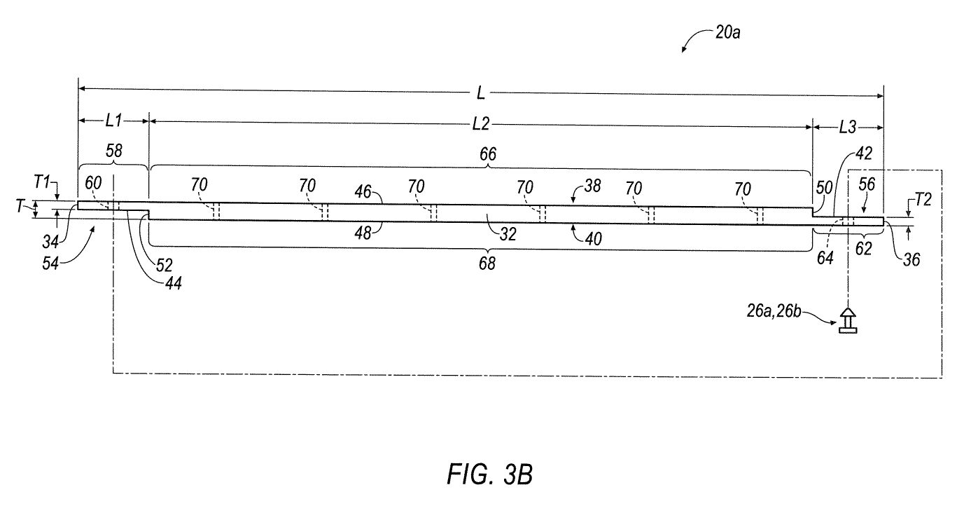

As seen, for example, in FIG. 5, each ring member 22a-22f of the plurality of ring members 22 may generally define a diameter, D, having a circumferential recess 76 that may be defined by a circumferential end surface 78, an inner radial surface 80 and an outer radial surface 82. In an embodiment, a circumference of each ring member 22a-22f includes a dimension that is substantially similar to the length, L, of the longitudinal side surfaces 30, 32 of the body member 20a. Further, in an embodiment, the distance between inner radial surface 80 and the outer radial surface 82 may be substantially equal to but slightly greater than the thickness, T.

In an embodiment, each ring member 22a-22f may include an opening or passage 77 that permits ingress or egress of an animal, A, relative the housing portion 12a. However, it will be appreciated that one or more of the ring members 22a-22f may include, for example, an end wall (not shown) that is located proximate/within the opening or passage 77 in order to function in a manner that impedes, restricts or completely prevents an animal, A, from entering or exiting the housing portion 12a by way of the ring member 22a-22f.

Referring to FIGS. 5-7, a portion of the first/second longitudinal side surface 30/32 of the body member 20a may be arranged substantially adjacent the circumferential end surface 78, the inner radial surface 80 and the outer radial surface 82 of the first/second ring members 22a/22b. In an embodiment, if the first and second layers of material 72, 74 are connected to the body member 20a, it will be appreciated that a portion of the first and second layers of material 72, 74 may be disposed within the circumferential recess 76 and be arranged substantially adjacent one or more of the circumferential end surface 78, the inner radial surface 80 and the outer radial surface 82.

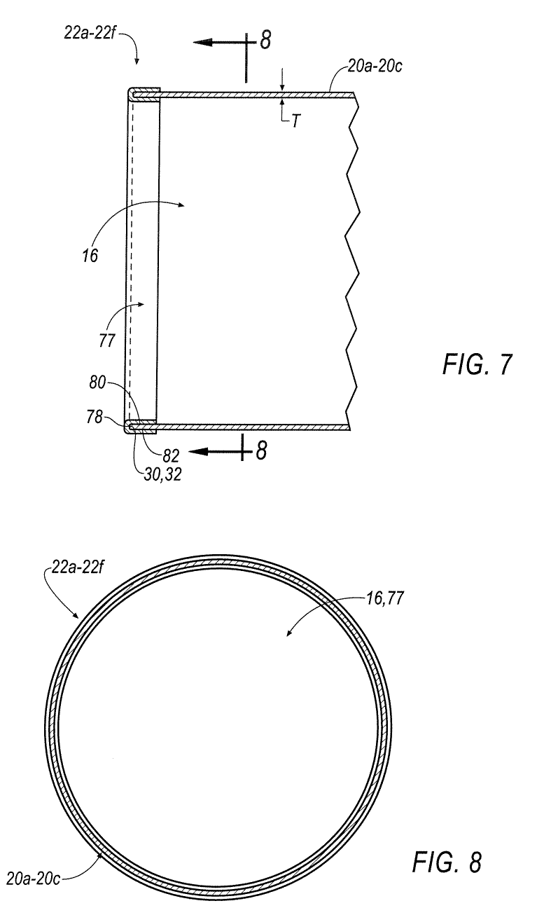

Referring to FIGS. 6 and 8, once one or more of the first and second ring members 22a, 22b are connected to the body member 20a, the first housing portion 12a of the plurality of housing portions 12 may be said to be formed. In an embodiment, as seen in FIGS. 4 and 6, the connection of the first end 54 to the second end 56 of the body member 20a may result in the body member 20a defining a seam 84.

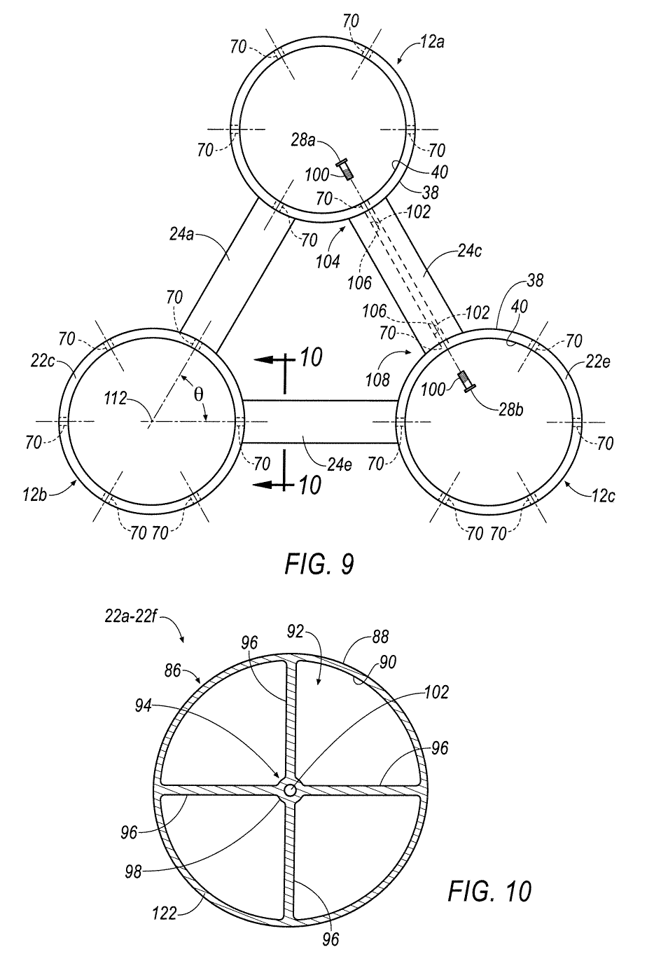

In an embodiment, referring to FIG. 2B, the user may conduct further steps to assemble the modular animalia housing apparatus 10 by retrieving the plurality of beam members 24 and the second plurality of fasteners 28 from the container, C. Referring to FIG. 9, a second housing portion 12b and a third housing portion 12c may be assembled as similarly described above, and, subsequently, the plurality of beam members 24 and the second plurality of fasteners 28 may be utilized to attach the plurality of housing portions 12 to one another.

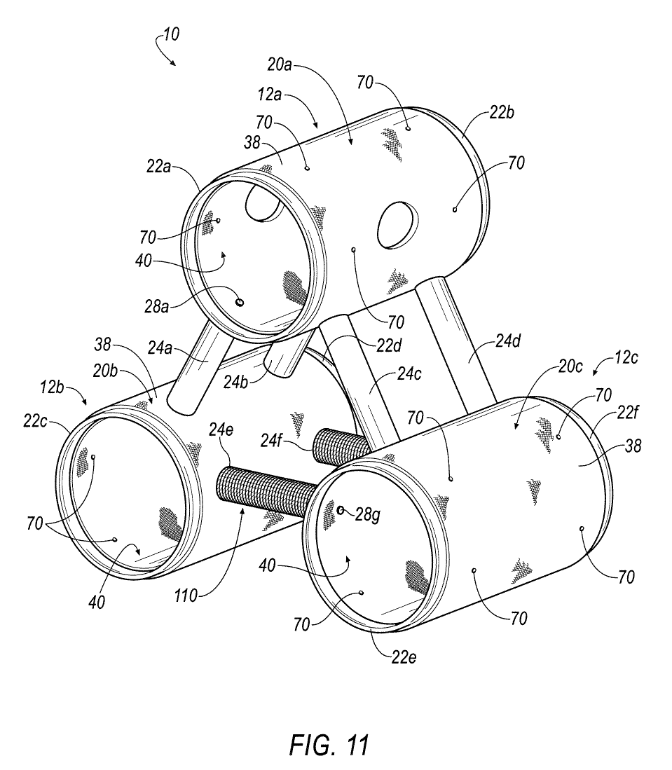

Referring to FIG. 10, in an embodiment, each beam member 24a-24f of the plurality of beam members 24 may include a substantially hollowed, tubular body 86. In an embodiment, each beam member 24a-24f may include an outer surface 88 and an inner surface 90 defining a central passage 92. In an embodiment, an axial core member 94 may extend axially through the central passage 92. In an embodiment, each beam member 24a-24f may include, but not limited to, any material such as paper material (e.g. a paperboard, cardboard, or the like), wood, wood composites, wood venire, sheet metal, MYLAR®, MYLAR® composites, nylon, nylon composites, resin, resin composites, carbon, carbon composites, or the like.

In an embodiment, a plurality of rib members 96 may extend radially outwardly from an outer surface 98 of the axial core member 94 for attachment to the inner surface 90 of the tubular body 86. It will be appreciated that hollowed structure of the tubular body 86 may reduce the overall weight of each beam member 24a-24f. Further, it will be appreciated that the axial core member 94 and the plurality of rib members 96 may increase the rigidity of each tubular body 86.

Referring to FIG. 9, in an embodiment, to connect the plurality of housing portions 12 to the plurality of beam members 24, the second plurality of fasteners 28 may be retrieved from the bag, B. In an embodiment a first fastener 28a of the second plurality of fasteners 28 may be inserted into a third passage 70 of the thickness, T, from the second portion 68 of the inner surface 40 and past the second portion 66 of the outer surface 38 of a first body member 20a such that an outer threaded portion 100 of the first fastener 28a may be inserted into an axial passage 102 of the axial core member 94 of a first axial end 104 of the beam member 24a-24f such that the outer threaded portion 100 may engage an inner threaded surface 106 of the axial passage 102. Then, a second fastener 28b of the second plurality of fasteners 28 may be inserted into a third passage 70 of the thickness, T, from the second portion 68 of the inner surface 40 and past the second portion 66 of the outer surface 38 of a second body member 20b such that an outer threaded portion 100 of the second fastener 28b may be inserted into the axial passage 102 of the axial core member 94 of a second axial end 108 of the beam member 24a-24f such that the outer threaded portion 100 may engage the inner threaded surface 106 of the axial passage 102.

Referring to FIG. 11, the above step of attaching neighboring body members 20a-20c with one or more beam members 24a-24f with the second plurality of fasteners 28 may be repeated several times until the plurality of housing portions 12 are connected to define an assembled modular animalia housing apparatus 10. In an embodiment, one or more of the plurality of beam members 24 may include a covering layer 110. In an embodiment, the covering layer 110 may include a tufted material, rope, or the like, that may function, for example, as a scratching post for a feline, A, or the like. Further, in an embodiment, the inner surface 40 of each body member 20a-20c may function as a seat, perch, housing or the like that permits, for example, a feline, to lounge or loiter thereupon.

Referring to FIG. 9, it will be appreciated that each of the one or more third passages 70 of the body members 20a-20c may be arranged in a manner such that when each body member 20a-20c is configured to be in a rolled, substantially tubular orientation, each neighboring passage 70 may be spaced relative one another at an angle, θ (e.g., approximately θ=60°), relative an axial center 112 of each body member 20a-20c. Accordingly, it will be appreciated that although the modular animalia housing apparatus 10 may be arranged in a substantially triangular orientation/configuration as seen in FIGS. 1, 9, 11 and 12A, the modular animalia housing apparatus 10 is not limited to a particular orientation/configuration.

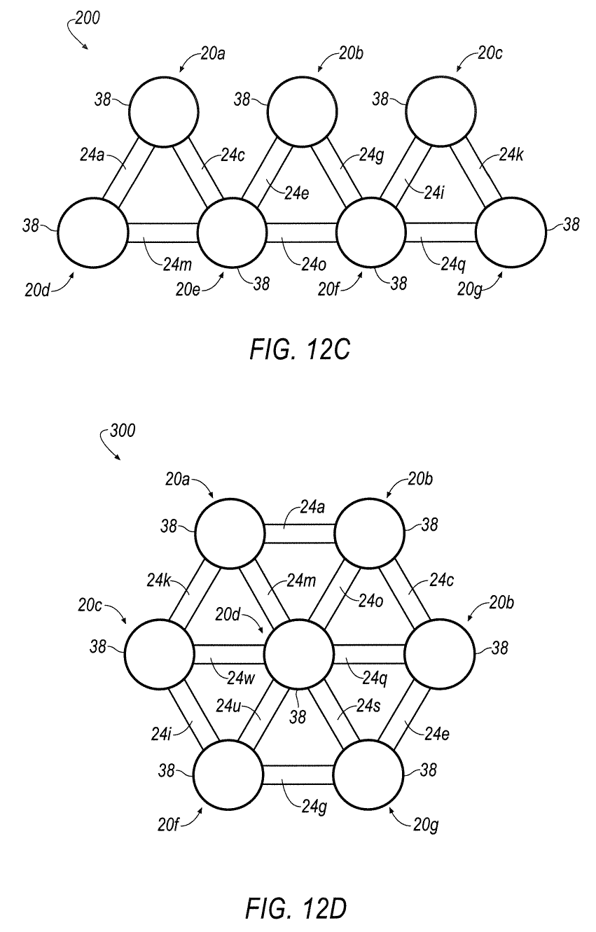

Referring to FIG. 12B, in an embodiment, a modular animalia housing apparatus 100 is shown that includes six body members 20a-20f and nine or more beam members 24 (e.g., eighteen beam members 24 when seen from a perspective view). In an embodiment, each of the body members 20a, 20d, 20f that arranged at corners of the modular animalia housing apparatus 100 includes two or more beam member 24 (e.g. four beam members 24 when seen from a perspective view) extending from its outer surface 38, whereas, in an embodiment, each of the remaining body members 20b, 20c, 20e of the modular animalia housing apparatus 100 includes four or more beam members 24 (e.g. eight beam members 24 when seen from a perspective view) extending from its outer surface 38. Accordingly, as seen in FIG. 12B, in an embodiment, the modular animalia housing apparatus 100 may be said to be arranged in a substantially triangular orientation.

Referring to FIG. 12C, in an embodiment, a modular animalia housing apparatus 200 is shown that includes seven body members 20a-20g and nine or more beam members 24 (e.g., eighteen beam members 24 when seen from a perspective view). In an embodiment, each of the body members 20a-20d and 20g that arranged at corners of the modular animalia housing apparatus 200 includes two or more beam member 24 (e.g. four beam members 24 when seen from a perspective view) extending from its outer surface 38, whereas, in an embodiment, each of the remaining body members 20e-20f of the modular animalia housing apparatus 200 includes four or more beam members 24 (e.g. eight beam members 24 when seen from a perspective view) extending from its outer surface 38. Accordingly, as seen in FIG. 12C, in an embodiment, the modular animalia housing apparatus 200 may be said to be arranged in a manner that includes three neighboring triangular structures that are connected by a pair of common body members (e.g., body members 20e-20f).

Referring to FIG. 12D, in an embodiment, a modular animalia housing apparatus 300 is shown that includes seven body members 20a-20g and twelve or more beam members 24 (e.g., twenty-four beam members 24 when seen from a perspective view). In an embodiment, each of the body members 20a-20c and 20e-20g that arranged at corners of the modular animalia housing apparatus 300 includes three or more beam member 24 (e.g. six beam members 24 when seen from a perspective view) extending from its outer surface 38, whereas, in an embodiment, the remaining central body member 20d of the modular animalia housing apparatus 300 includes six or more beam members 24 (e.g. twelve beam members 24 when seen from a perspective view) extending from its outer surface 38. Accordingly, as seen in FIG. 12D, in an embodiment, the modular animalia housing apparatus 300 may be said to be arranged in an substantially hexagonal orientation such that each of the corner body members 20a-20c and 20e-20g are connected to a common, central body member (e.g., body member 20d).

Accordingly, in an embodiment, in view of the arrangements of the modular animalia housing apparatus 10, 100, 200, 300 shown at FIGS. 12A-12D, it will be appreciated that a container, C, may include an appropriate number of components 18 to assemble the arrangements of the modular animalia housing apparatus 10, 100, 200, 300 shown at FIGS. 12A-12D, or, alternatively, a user may purchase a plurality of containers, C, and build a plurality of animalia housing apparatuses into any desirable number of sub-structures (see, e.g., FIG. 12C), or, alternatively, a “super-structure” (see, e.g., FIG. 12D). Accordingly, the arrangement of neighboring passages 70 that define a particular angle, θ, permits each body member 20a-20c to be modular such that a user is not limited to assembling, for example, a triangular structure (see, e.g., FIGS. 12A, 12B), and may, for example, assemble a hexagonal structure (see, e.g., FIG. 12D).

Further, it will be appreciated that each body member 20a-20c is not limited to including a particular number of passages 70, nor a particular arrangement of neighboring passages 70 that define a particular angle, θ. In an embodiment, for example, each body member 20a-20c may include four passages 70 that define an angle approximately equal to θ=90°. Accordingly, it will be appreciated that fewer or additional passages 70 permits a user to assemble the modular animalia housing apparatus 10, 100, 200, 300 into a lesser or greater number of potential configurations.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A modular animalia housing apparatus, comprising:
one or more housing portions, wherein the one or more housing portions each includes a substantially tube-shaped body member having a first end connected to a second end, wherein the substantially tube-shaped body member is formed from a substantially planar member including:
a length,
a width, and
a thickness, wherein the length includes
a first length segment,
a second length segment, and
a third length segment, wherein the second length segment is joined to the first length segment and the third length segment, where the first end includes the first length segment, wherein the second end includes the third length segment, wherein the second length segment includes the thickness, wherein the first length segment includes
a first thickness portion that is less than the thickness, wherein the third length segment includes
a second thickness portion that is less than the thickness, wherein a sum of the first thickness portion and the second thickness portion is approximately equal to the thickness.

2. The modular animalia housing apparatus according to claim 1, further comprising one or more fasteners that attaches the first end to the second end.

3. The modular animalia housing apparatus according to claim 2, wherein the one or more fasteners includes one or more one-way fasteners that are inserted through one or more passages formed in the first end and the second end.

4. The modular animalia housing apparatus according to claim 1, wherein the body member includes a first longitudinal side surface, a second longitudinal side surface, a first lateral side surface, a second lateral side surface, an outer surface and an inner surface.

5. The modular animalia housing apparatus according to claim 4, wherein the first end includes the first lateral side surface and a portion of the inner surface that is substantially perpendicular to an intermediate surface portion of the inner surface, wherein the second end includes the second lateral side surface and a portion of the outer surface that is substantially perpendicular to an intermediate portion of the outer surface.

6. The modular animalia housing apparatus according to claim 4, further comprising:
one or more ring members attached to one or more of the first longitudinal side surface and the second longitudinal side surface.

7. The modular animalia housing apparatus according to claim 1, further comprising:
one or more beam members that attach at least two housing portions of the one or more housing portions.

8. The modular animalia housing apparatus according to claim 7, further comprising:
one or more fasteners that attach the one or more beam members to the at least two housing portions of the one or more housing portions.

9. The modular animalia housing apparatus according to claim 8, wherein the one or more beam members each include an outer surface and an inner surface, wherein the inner surface defines a central passage, wherein the one or more beam members include an axial core member extending through the central passage, wherein the one or more beam members each include a plurality of rib members extending radially outwardly from an outer surface of the axial core member to the inner surface of each of the one or more beam members.

10. A modular animalia housing apparatus, comprising:
one or more housing portions, wherein the one or more housing portions is/are each formed from a substantially planar member that is formed into a substantially tube-shaped body member having a first end and a second end;
one or more ring members, wherein a ring member of the one or more ring members is attached to one or more of the first end and the second end; and
one or more beam members that attach at least two housing portions of the one or more housing portions.

11. The modular animalia housing apparatus according to claim 10, further comprising one or more fasteners, wherein the one or more fasteners provide,
means for maintaining the substantially planar member in the form of the substantially tube-shaped body member.

12. The modular animalia housing apparatus according to claim 11, wherein the one or more fasteners includes one or more one-way fasteners that are inserted through one or more passages formed in the substantially planar member.

13. The modular animalia housing apparatus according to claim 10, wherein the substantially planar member includes a first longitudinal side surface, a second longitudinal side surface, a first lateral side surface, a second lateral side surface, an outer surface and an inner surface.

14. The modular animalia housing apparatus according to claim 10, further comprising one or more fasteners, wherein the one or more fasteners provide:
means for attaching the one or more beam members to the at least two housing portions of the one or more housing portions.

15. The modular animalia housing apparatus according to claim 15, wherein the one or more beam members each include an outer surface and an inner surface, wherein the inner surface defining a central passage, wherein the one or more beam members include an axial core member extending through the central passage, wherein the one or more beam members each include a plurality of rib members extending radially outwardly from an outer surface of the axial core member to the inner surface of each of the one or more beam members.

16. The modular animalia housing apparatus according to claim 10, wherein the substantially tube-shaped body member is formed from a length, a width, and a thickness, wherein the length includes a first length segment, a second length segment, and a third length segment, wherein the second length segment is joined to the first length segment and the third length segment, wherein the second length segment includes the thickness, wherein the first length segment includes a first thickness portion, wherein the third length segment includes a second thickness portion, wherein a sum of the first thickness portion and the second thickness portion is approximately equal to the thickness.

17. A kit for assembling into a modular animalia housing apparatus, comprising:
one or more substantially flat body members that is/are each adapted to form one or more substantially tube-shaped housing portions;
one or more ring members that are adapted to be attached to the one or more of the substantially tube-shaped housing portions; and
one or more beam members that are adapted to be attached to at least two of the substantially tube-shaped housing portions.

18. The kit for assembling modular animalia housing apparatus according to claim 17, wherein the one or more substantially flat body members each include a first longitudinal side, a second longitudinal side, a first lateral side, a second lateral side, an outer surface and an inner surface, wherein at least a portion of the outer surface is adapted to be connected to at least a portion of the inner surface to form the one or more substantially flat body members into the one or more substantially tube-shaped housing portions.

19. The kit for assembling modular animalia housing apparatus according to claim 18, wherein the one or more ring members are adapted to be attached to one or more of the first longitudinal side and the second longitudinal side when the one or more substantially flat body members are formed into the one or more substantially tube-shaped housing portions.

20. The kit for assembling modular animalia housing apparatus according to claim 18, wherein the one or more beam members are adapted to be attached to the outer surface of the one or more substantially flat body members for attaching the at least two of the substantially tube-shaped housing portions.

21. The kit for assembling modular animalia housing apparatus according to claim 20, further comprising:
one or more first fasteners that are adapted to attach the portion of the outer surface to the portion of the inner surface; and
one or more second fasteners that are adapted to attach the one or more beam members to the outer surface of the one or more substantially flat body members.

22. The kit for assembling modular animalia housing apparatus according to claim 21, wherein the one or more first fasteners include one or more one-way fasteners, wherein the one or more second fasteners include one or more threaded fasteners.
